(19) United States
(12) Patent Application Publication
(10) Pub. No.: US 2015/0206493 A1
(43) Pub. Date: Jul. 23, 2015

(54) DEVICES AND METHODS FOR REDUCING OR ELIMINATING MURA ARTIFACT

(71) Applicant: APPLE INC., Cupertino, CA (US)

(72) Inventors: Cheng-Ho Yu, Cupertino, CA (US); Ting-Kuo Chang, Cupertino, CA (US); Abbas Jamshidi-Roudbari, Sunnyvale, CA (US); Shih Chang Chang, Cupertino, CA (US)

(73) Assignee: APPLE INC., Cupertino, CA (US)

(21) Appl. No.: 14/160,230

(22) Filed: Jan. 21, 2014

(51) Int. Cl. G09G 3/36; G09G 3/32

(52) U.S. Cl. CPC G09G 3/3696; G09G 3/32; G09G 2300/043; G09G 2300/0426

(57) ABSTRACT

Devices and methods for reducing or eliminating image artifacts are provided. By way of example, a display panel includes row common voltage (VCOM) electrodes each having a first width. The row VCOM electrodes extend along a first direction of the display panel. The display panel also includes column VCOM electrodes each having a second width. The column VCOM electrodes extend along a second direction of the display panel perpendicular to the first direction. The second width of the column VCOM electrodes may be substantially less than the first width of the row VCOM electrodes to increase a resistance of the column VCOM electrodes. By increasing the resistance of the column VCOM electrodes, image artifacts on the display panel may be prevented or eliminated.

### BACKGROUND

The present disclosure relates generally to electronic displays and, more particularly, to electronic displays having reduced or eliminated mura artifacts.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Electronic displays commonly appear in electronic devices such as televisions, computers, and phones. One type of electronic display, known as a liquid crystal display (LCD), displays images by modulating the amount of light allowed to pass through a liquid crystal layer within pixels of the LCD. In general, LCDs modulate the light passing through each pixel by varying a voltage difference between a pixel electrode and a common electrode. This creates an electric field that causes the liquid crystal layer to change alignment. The change in alignment of the liquid crystal layer causes more or less light to pass through the pixel. By changing the voltage difference (often referred to as a data signal) supplied to each pixel, images are produced on the LCD.

Conventionally, the common electrodes of the pixels of the LCD are all formed from a single common voltage layer (VCOM). Thus, to the extent that undesirable bias voltages or voltage perturbations may occur in the VCOM, any resulting negative effects would be distributed over the entire LCD. When an LCD includes multiple VCOMs, however, it is believed that undesirable bias voltages or voltage perturbations may occur differentially on the various VCOMs. These differential bias voltages or voltage perturbations could produce visible artifacts known as muras, or largely permanent display screen artifacts.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Embodiments of the present disclosure relate to systems, methods, and devices for reducing or eliminating mura artifacts in electronic displays, such as liquid crystal displays (LCDs) or organic light emitting diode (OLED) displays. In a particular example, it is believed that certain artifacts or muras could arise in an LCD having multiple distinct common voltage layers (VCOMs). For example, an LCD with VCOMs generally arranged in alternating rows and columns may exhibit a vertical stripe feature of merit (VSFOM). The VSFOM may appear as alternating light and dark vertical stripes along the LCD.

Various embodiments of the present disclosure may reduce and/or substantially eliminate artifacts (e.g., VSFOM). By way of example, a display panel may include a number of row common voltage (VCOM) electrodes each having a first width. The row VCOM electrodes extend along a first direction of the display panel. The display panel may also include column VCOM electrodes each having a second width. The row VCOM electrodes extend along a second direction of the display panel perpendicular to the first direction. The second width of the column VCOM electrodes may be substantially less than the first width of the row VCOM electrodes to increase a resistance of the column VCOM electrodes in relation to a resistance of the row VCOM electrodes that would occur if the second width were the same as the first width. Specifically, the resistance of the column VCOM electrodes may be increased to substantially prevent or otherwise reduce an occurrence of an image artifact on the display panel. Additionally or alternatively, breaches or discontinuances in the column VCOM electrodes may be used to increase the resistance of the column VCOM electrodes. Specifically, the resistance of the column VCOM electrodes may be increased to substantially equal the resistance of the row VCOM electrodes, thereby substantially eliminating an occurrence of an image artifact on the display panel.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a schematic block diagram of an electronic device with a liquid crystal display (LCD) having in-cell touch sensor components, in accordance with an embodiment;

FIG. 2 is a perspective view of a notebook computer representing an embodiment of the electronic device of FIG. 1;

FIG. 3 is a front view of a hand-held device representing another embodiment of the electronic device of FIG. 1;

FIG. 4 is a circuit diagram of switching a display circuitry of pixels of an LCD, in accordance with an embodiment;

FIG. 5 is a schematic block diagram of the multiple VCOMs of the LCD, in accordance with an embodiment;

FIG. 6 is a block diagram of the row VCOMs and column VCOMs having a decreased physical width, in accordance with an embodiment;

FIGS. 7-10 depict example embodiments of column VCOMs including a single floating electrode discontinuance, in accordance with an embodiment;

FIGS. 11-13 depict example embodiments of column VCOMs including segmented electrode discontinuances, in accordance with an embodiment;

FIG. 14 is a flowchart illustrating an embodiment of a process suitable for reducing mura artifacts (VSFOM) by providing column VCOMs of decreased width, in accordance with an embodiment;

FIG. 15 is a flowchart illustrating an embodiment of a process suitable for reducing mura artifacts (VSFOM) by providing column VCOMs including one or more discontinuances, in accordance with an embodiment;

FIG. 16 is a plot diagram illustrating mura artifact (VSFOM) visibility as a function of TFT gate clock rising edge shift for one or more column VCOM resistance values, in accordance with an embodiment; and

FIG. 17 is a timing diagram illustrating the voltage characteristics of the row VCOMs and the column VCOMs caused by TFT deactivation, in accordance with an embodiment.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As previously noted, embodiments of the present disclosure relate to liquid crystal displays (LCDs) and electronic devices incorporating LCDs that employ touch sensor components within display pixel cells (“in-cell”). Specifically, in-cell touch technology (e.g., in-cell touch charge sensing) may be susceptible to mura artifacts becoming apparent on the display. In a particular example, it is believed that certain artifacts or muras could arise in an LCD having multiple distinct common voltage layers (VCOMs). For example, an LCD with VCOMs generally arranged in alternating rows and columns may exhibit a vertical stripe feature of merit (VSFOM). The VSFOM may appear as alternating light and dark vertical stripes along the LCD.

Accordingly, various embodiments of the present disclosure may reduce and/or substantially eliminate artifacts (e.g., VSFOM), including those due to differential voltages or voltage perturbations on multiple distinct VCOMs. In one embodiment, the mura artifacts may be reduced and/or substantially eliminated by fabricating the column VCOMs to include a physical width that is substantially less than the physical width of the row VCOMs. The deduction in width of the column VCOMs may lead to an increase in resistance on the column VCOMs, and may cause the resistance on the column VCOMs to equal that of row VCOMs in order to reduce and/or substantially eliminate the occurrence of mura artifacts on the display.

In another embodiment, artifacts (e.g., VSFOM) may be reduced and/or substantially eliminated by fabricating the column VCOMs to include one or more discontinuances (e.g., segments and/or breaches in the electrodes of the column VCOMs) to increase the resistance on the column VCOMs. That is, as will be further appreciated, the column VCOMs may include electrode segments, such that the column VCOM electrodes may create one or more “floating” electrodes and may not touch or interfere with the row VCOM electrodes as the electrodes intersect. Such an arrangement may further increase the resistance of the column VCOMs, and may thus reduce and/or substantially eliminate the occurrence of mura artifacts on the display.

As used herein, “row” may refer to at least one axis of an array or matrix of components (e.g., row VCOM electrodes) on which the components may be substantially aligned. Similarly, “column” may refer to at least one other axis of the array or the matrix of components that may intersect and/or extend in a direction perpendicular to the row axis, and on which other similar components (e.g., column VCOM electrodes) may be substantially aligned. That is, the “rows” and the “columns” may be respectively understood to refer to any one of at least two axes, in which the two axes are substantially perpendicular. Additionally, the term “mura” may refer to a visual artifact that may remain at least partially visible when the display is on. The nature of mura artifacts may depend on the arrangement of the internal components of the display. For example, when VCOM electrodes are generally arranged in rows and columns as discussed above, the resulting mura artifact(s) may form what may be referred to as a vertical stripe feature of merit (VSFOM), or a manifestation of light and/or dark stripes oriented parallel to, for example, the source lines of the display. Specifically, it should be appreciated that mura artifact and/or VSFOM may manifest as light and/or dark stripes that may appear vertically and/or horizontally with respect to, for example, the viewpoint of a user of the display.

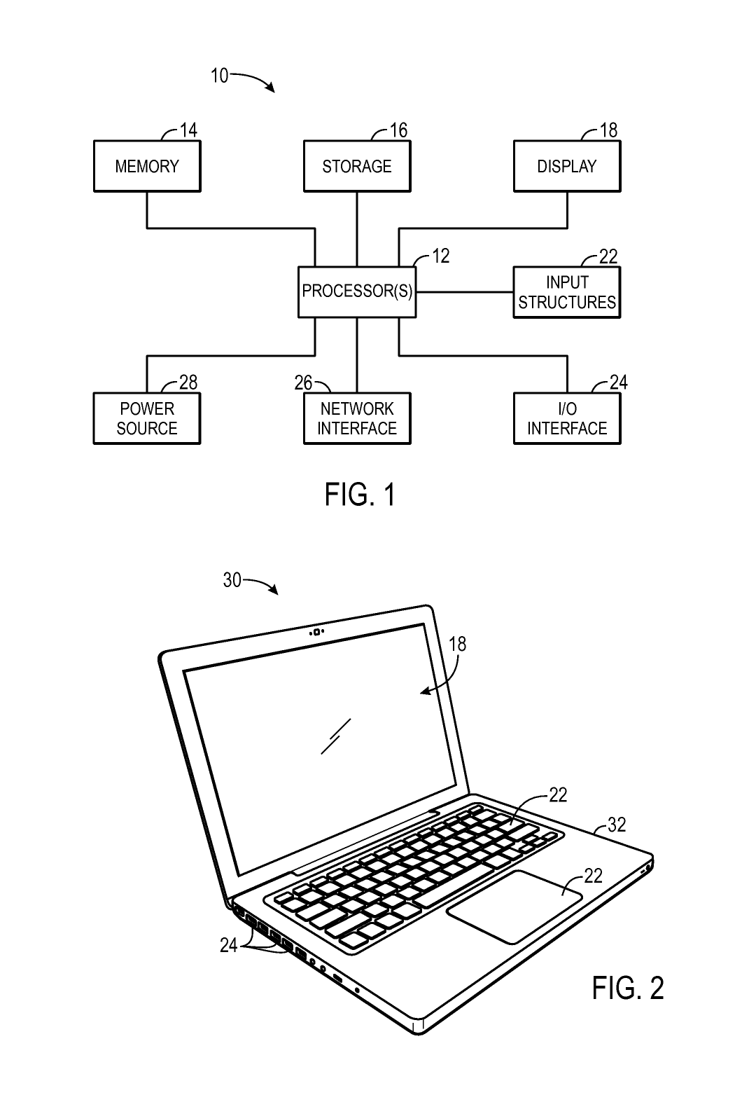

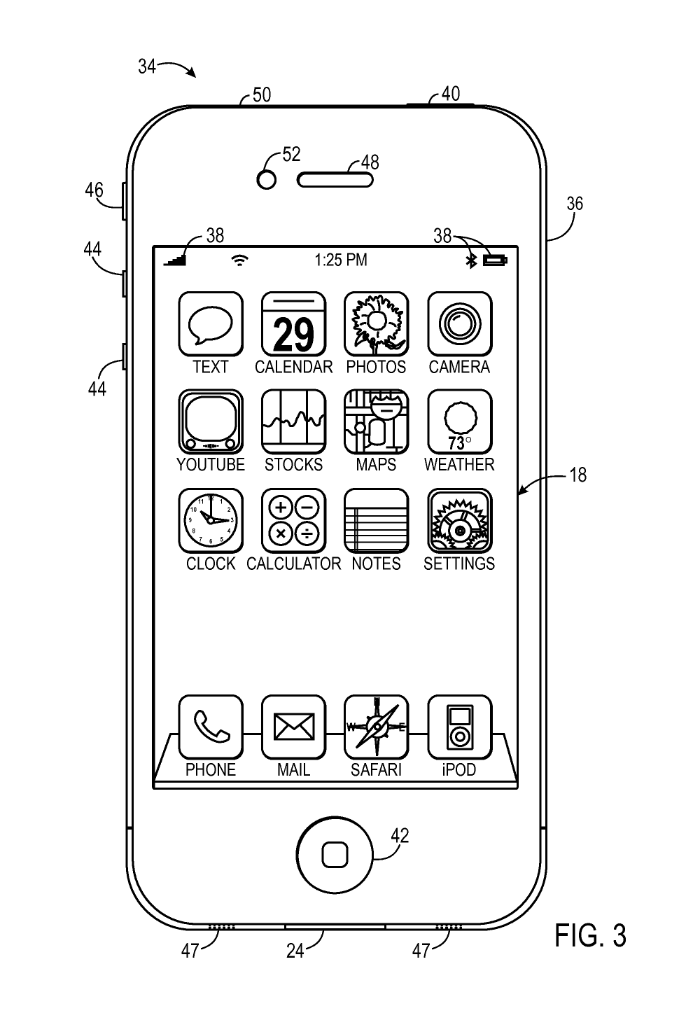

With the foregoing in mind, a general description of suitable electronic devices that may employ electronic touch screen displays having in-cell touch components and are useful in reducing and/or substantially eliminating the mura artifacts that may become apparent on the display will be provided below. In particular, FIG. 1 is a block diagram depicting various components that may be present in an electronic device suitable for use with such a display. FIGS. 2 and 3 respectively illustrate perspective and front views of suitable electronic device, which may be, as illustrated, a notebook computer or a handheld electronic device.

Turning first to FIG. 1, an electronic device 10 according to an embodiment of the present disclosure may include, among other things, one or more processor(s) 12, memory 14, nonvolatile storage 16, a display 18 having in-cell touch sensor components, input structures 22, an input/output (I/O) interface 24, network interfaces 26, and a power source 28. The various functional blocks shown in FIG. 1 may include hardware elements (including circuitry), software elements (including computer code stored on a computer-readable medium) or a combination of both hardware and software elements. It should be noted that FIG. 1 is merely one example of a particular implementation and is intended to illustrate the types of components that may be present in electronic device 10.

By way of example, the electronic device 10 may represent a block diagram of the notebook computer depicted in FIG. 2, the handheld device depicted in FIG. 3, or similar devices. It should be noted that the processor(s) 12 and/or other data processing circuitry may be generally referred to herein as “data processing circuitry.” Such data processing circuitry may be embodied wholly or in part as software, firmware, hardware, or any combination thereof. Furthermore, the data processing circuitry may be a single contained processing module or may be incorporated wholly or partially within any of the other elements within the electronic device 10.

In the electronic device 10 of FIG. 1, the processor(s) 12 and/or other data processing circuitry may be operably coupled with the memory 14 and the nonvolatile memory 16 to perform various algorithms for responding appropriately to a user touch on the display 18. Such programs or instructions executed by the processor(s) 12 may be stored in any suitable article of manufacture that includes one or more tangible, computer-readable media at least collectively storing the instructions or routines, such as the memory 14 and the nonvolatile storage 16. The memory 14 and the nonvolatile storage 16 may include any suitable articles of manufacture for storing data and executable instructions, such as random-access memory, read-only memory, rewritable flash memory, hard drives, and optical discs. Also, programs (e.g., an operating system) encoded on such a computer program product may also include instructions that may be executed by the processor(s) 12 to enable the electronic device 10 to provide various functionalities.

The display 18 may be a touch screen liquid crystal display (LCD), which may allow users to interact with a user interface of the electronic device 10. Various touch sensor components, such as touch sense and/or touch drive electrodes may be located within display pixel cells of the display 18. As mentioned above, in-cell touch sensor components may include integrated display panel components serving a secondary role as touch sensor components. As such, it should be appreciated that the in-cell touch sensor components may be formed from a gate line of the display, a pixel electrode of the display, a common electrode of the display, a source line of the display, or a drain line of the display, or some combination of these elements.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interfaces 26. The network interfaces 26 may include, for example, interfaces for a personal area network (PAN), such as a Bluetooth network, for a local area network (LAN), such as an 802.11x Wi-Fi network, and/or for a wide area network (WAN), such as a 3G or 4G cellular network. The power source 28 of the electronic device 10 may be any suitable source of power, such as a rechargeable lithium polymer (Li-poly) battery and/or an alternating current (AC) power converter.

The electronic device 10 may take the form of a computer or other type of electronic device. Such computers may include computers that are generally portable (such as laptop, notebook, and tablet computers) as well as computers that are generally used in one place (such as conventional desktop computers, workstations and/or servers). In certain embodiments, the electronic device 10 in the form of a computer may be a model of a MacBook®, MacBook® Pro, MacBook Air®, iMac®, Mac® mini, or Mac Pro® available from Apple Inc. By way of example, the electronic device 10, taking the form of a notebook computer 30, is illustrated in FIG. 2 in accordance with one embodiment of the present disclosure. The depicted computer 30 may include a housing 32, a display 18, input structures 22, and ports of an I/O interface 24. In one embodiment, the input structures 22 (such as a keyboard and/or touchpad) may be used to interact with the computer 30, such as to start, control, or operate a GUI or applications running on computer 30. For example, a keyboard and/or touchpad may allow a user to navigate a user interface or application interface displayed on display 18. The display 18 may be relatively thin and/or bright, as the in-cell touch components may not require an additional capacitive touch panel overlaid on it.

FIG. 3 depicts a front view of a handheld device 34, which represents one embodiment of the electronic device 10. The handheld device 34 may represent, for example, a portable phone, a media player, a personal data organizer, a handheld game platform, or any combination of such devices. By way of example, the handheld device 34 may be a model of an iPod® or iPhone® available from Apple Inc. of Cupertino, Calif. In other embodiments, the handheld device 34 may be a tablet-sized embodiment of the electronic device 10, which may be, for example, a model of an iPad® available from Apple Inc.

The handheld device 34 may include an enclosure 36 to protect interior components from physical damage and to shield them from electromagnetic interference. The enclosure 36 may surround the display 18, which may display indicator icons 38. The indicator icons 38 may indicate, among other things, a cellular signal strength, Bluetooth connection, and/or battery life. The I/O interfaces 24 may open through the enclosure 36 and may include, for example, a proprietary I/O port from Apple Inc. to connect to external devices.

User input structures 40, 42, 44, and 46, in combination with the display 18, may allow a user to control the handheld device 34. For example, the input structure 40 may activate or deactivate the handheld device 34, the input structure 42 may navigate user interface to a home screen, a user-configurable application screen, and/or activate a voice-recognition feature of the handheld device 34, the input structures 44 may provide volume control, and the input structure 46 may toggle between vibrate and ring modes. A microphone 48 may obtain a user's voice for various voice-related features, and a speaker 50 may enable audio playback and/or certain phone capabilities. A headphone input 52 may provide a connection to external speakers and/or headphones. As mentioned above, the display 18 may be relatively thin and/or bright, as the in-cell touch components may not require an additional capacitive touch panel overlaid on it.

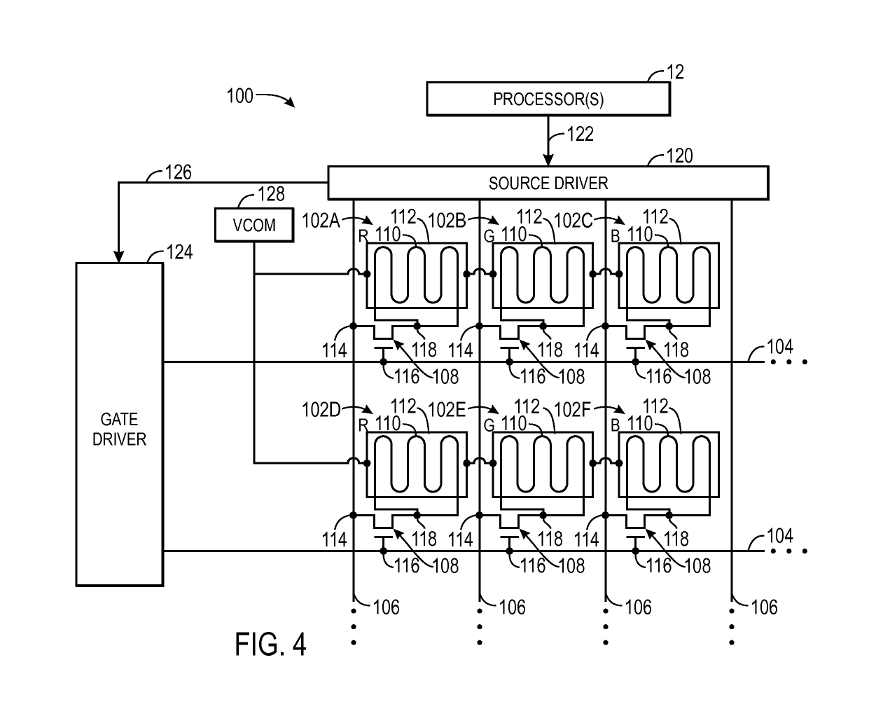

FIG. 4 generally represents a circuit diagram of certain components of the display 18 in accordance with some embodiments. In particular, the pixel array 100 of the display 18 may include a number of unit pixels 102 disposed in a pixel array or matrix. In such an array, each unit pixel 102 may be defined by the intersection of rows and columns, represented by gate lines 104 (also referred to as scanning lines), and source lines 106 (also referred to as data lines), respectively. Although only 6 unit pixels 102, referred to individually by the reference numbers 102a-102f, respectively, are shown for purposes of simplicity, it should be understood that in an actual implementation, each source line 106 and gate line 104 may include hundreds or thousands of such unit pixels 102. Each of the unit pixels 102 may represent one of three subpixels that respectively filters only one color (e.g., red, blue, or green) of light through, for example, a color filter. For purposes of the present disclosure, the terms “pixel,” “subpixel,” and “unit pixel” may be used largely interchangeably.

In the presently illustrated embodiment, each unit pixel 102 may include a thin film transistor (TFT) 108 for switching a data signal stored on a respective pixel electrode 110. The potential stored on the pixel electrode 110 relative to a potential of a common electrode 112, which may be shared by other pixels 102, may generate an electrical field sufficient to alter the arrangement of liquid crystal molecules (not illustrated in FIG. 4). In the depicted embodiment of FIG. 4, a source 114 of each TFT 108 may be electrically connected to a source line 106 and a gate 116 of each TFT 108 may be electrically connected to a gate line 104. A drain 118 of each TFT 108 may be electrically connected to a respective pixel electrode 110. Each TFT 108 may serve as a switching element that may be activated and deactivated (e.g., turned on and turned off) for a predetermined period of time based on the respective presence or absence of a scanning signal on the gate lines 104 that are applied to the gates 116 of the TFTs 108.

When activated, a TFT 108 may store the image signals received via the respective source line 106 as a charge upon its corresponding pixel electrode 110. As noted above, the image signals stored by the pixel electrode 110 may be used to generate an electrical field between the respective pixel electrode 110 and a common electrode 112. This electrical field may align the liquid crystal molecules to modulate light transmission through the pixel 102.

The display 18 also may include a source driver integrated circuit (IC) 120, which may include a chip, such as a processor or application specific integrated circuit (ASIC) that controls the display pixel array 100 by receiving image data 122 from the processor(s) 12, and sending corresponding image signals to the unit pixels 102 of the pixel array 100. The source driver 120 may also provide timing signals 126 to the gate driver 124 to facilitate the activation/deactivation of individual rows of pixels 102. In other embodiments, timing information may be provided to the gate driver 124 in some other manner. The display 18 may or may not include a common voltage (VCOM) source 128 to provide a common voltage (VCOM) voltage to the common electrodes 112. In certain embodiments, the VCOM source 128 may supply a different VCOM to different common electrodes 112 at different times. In other embodiments, the common electrodes 112 all may be maintained at the same potential or similar potential.

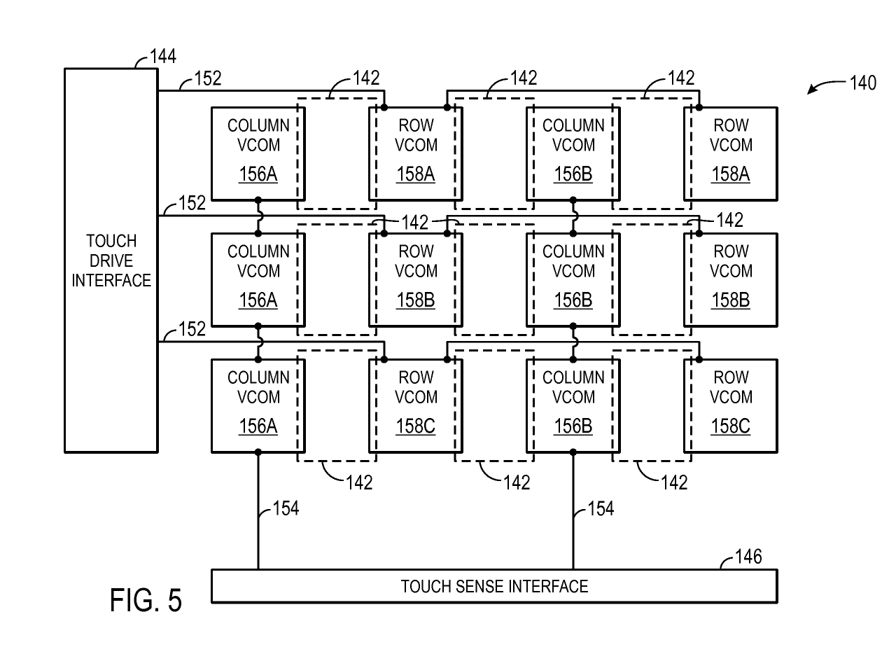

In certain embodiments, as illustrated in FIG. 5, a touch pixel array 140 may include an N×M of touch pixels 142 (e.g., a 6×10 matrix or other size matrix of touch pixels 142). These touch pixels 142 arise due to interactions between touch drive electrodes 152 and touch sense electrodes 154. It should be noted that the terms “lines” and “electrodes” as sometimes used herein simply refers to conductive pathways, and is not intended to be limited to structures that are strictly linear. Rather, the terms “lines” and “electrodes” may encompass pathways that change direction, of different size, shape, materials, and regions. The touch drive electrodes 152 may be driven, for example, by one or more touch drive signals.

The sense lines 154 may respond differently to the touch drive signals when an object, such as a finger, is located near the confluence of a given touch drive electrode 152 and a given touch sense electrode 154. The presence of the object may be “seen” by the touch pixel 142 that may result at an intersection of the touch drive electrode 152 and the touch sense electrode 154. That is, the touch drive electrodes 152 and the touch sense electrodes 154 may form capacitive sensing nodes, or more aptly, the touch pixels 142. It should be appreciated that the respective touch drive electrodes 152 and touch sense electrodes 154 may be formed, for example, from dedicated touch drive electrodes 152 and/or dedicated touch sense electrodes 154, and/or may be formed from one or more gate lines 104 of the display 18, one or more pixel electrodes 110 of the display 18, one or more common electrodes 112 of the display 18, or some combination of these elements.

For example, as further illustrated in FIG. 5, the touch drive electrodes 152 and touch sense electrodes 154 may include column VCOM 156 electrodes and row VCOM 158 electrodes. It should be appreciated that although FIG. 5 depicts only a few column VCOMs 156A and 156B and row VCOMs 158, an actual implementation of the display 18 may include any suitable number of column VCOMs 156 and row VCOMs 158. As previously noted, the column VCOMs 156 and row VCOMs 158 may gather touch sense information when operating in what may be referred to herein as a touch mode of operation. Though the column VCOMs 156 and row VCOMs 158 may be supplied the same direct current (DC) bias voltage, for example, in some embodiments, different alternating current (AC) voltages may be supplied and/or received on VCOMs 156 and 158 at substantially different times. For example, as previously noted, the display 18 may be useful in switching between two modes of operation: a display mode of operation and the touch mode of operation.

In the display mode, the column VCOMs 156 and the row VCOMs 158 may operate in the aforementioned manner, in which an electric field is generated between the column and row VCOMs 156 and 158 and respective pixel electrodes 110. The electric field may modulate the liquid crystal molecules to allow a certain amount of light to pass through the pixel. Thus, an image may be displayed on the display 18 in the display mode. In the touch mode, the row VCOM 158 and the column VCOM 156 may be used to sense a touch on the display 18 even while an image remains displayed on the display 18. In certain embodiments, a stimulus signal or voltage may be provided by the row VCOM 158. The column VCOM 156 may receive a touch signal and output the data to be processed, for example, by the processor(s) 12. The touch signal may be generated when a user, for example, touches and/or hover a finger nearby the display 18, creating capacitive coupling with a portion of the row VCOM 158 and a portion of the column VCOM 158. Thus, the portion of the column VCOM 156 may receive a signal indicative of the touch and/or hover.

In some embodiments, at least partially due to the configuration of the row VCOMs 158—namely, that the row VCOMs 158 are in line with the gate lines 104—the row VCOMs 158 may experience greater interference from voltage changes in the gate line 104 due to TFT gate deactivation. Since each of the column VCOMs 156 may extend down the display 18, and thus only shares a relatively small part its total area with a given gate line 104, the column VCOMs 156 may experience comparatively less. Moreover, the column VCOMs 156 and the row VCOMs 158 may have different inherent resistances (e.g., R_{CVCOM} and R_{RVCOM}) between respective voltage supplies, as well as different capacitances between the gate lines 104. The effect of these different VCOM characteristics, as well as different amounts of exposure to the gate lines 104, may produce different voltage perturbations on the column VCOMs 156 and the row VCOMs 158.

Moreover, in some embodiments, the different transient voltage perturbations may cause mura artifacts appearing, for example, as vertical stripes (e.g., VSFOM) on the display 18. Specifically, the resistance on the column VCOM electrodes 156 and the row VCOM electrodes 158 may be inversely proportional to the physical width of the VCOM electrodes 156 and 158. However, the resistance on the row VCOM electrodes 158 may be generally higher than that of the column VCOM electrodes 156 due to, for example, the varying voltage on the pixel electrodes 110. Thus, as will be further appreciated, to reduce and/or substantially eliminate the occurrence of mura artifacts, it may be useful, in some embodiments, to fabricate the column VCOMs 156 to include a physical width that is substantially less than the physical width of the row VCOMs 158. The reduction in width of the column VCOMs 156 may lead to an increase in resistance on the column VCOMs 156, and possibly cause the resistance on the column VCOMs 156 to equal that of row VCOMs 158 in order to reduce and/or substantially eliminate the occurrence of mura artifacts on the display 18.

In other embodiments, it may be useful to fabricate the column VCOMs 156 to include one or more discontinuities (e.g., segments and/or breaches in the electrodes of the column VCOMs 156) to increase the resistance on the column VCOMs 156. Thus, as will be further appreciated, the column VCOMs may include electrode segments, such that the column VCOM electrodes may create one or more “floating” electrodes and may not touch or interfere with the row VCOM electrodes as the electrodes intersect. Such an arrangement may further increase the resistance of the column VCOMs 156, and may thus reduce and/or substantially eliminate the occurrence of mura artifacts on the display 18. It should be appreciated that the present techniques (e.g., including providing the decreased width and/or the one or more discontinuances) may be applied alternatively and/or in conjunction with each other. For example, the column VCOMs may be provided with a decreased width, one or more discontinuances, or with both the decreased width and the one or more discontinuances.

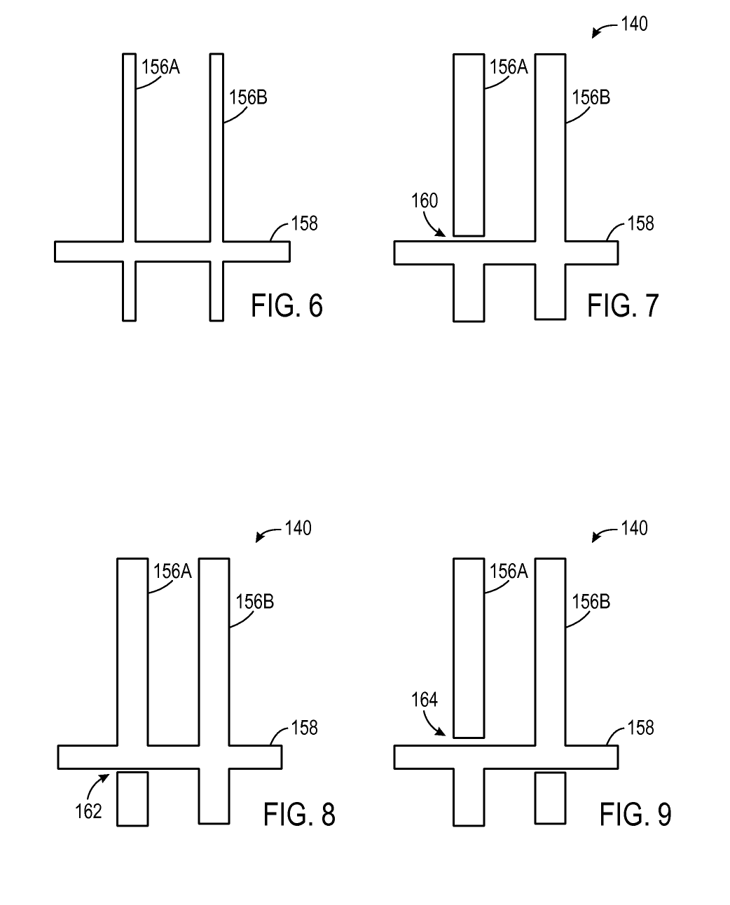

Turning now to FIG. 6, which illustrates an embodiment of the column VCOMs 156 and the row VCOMs 158, in which the column VCOMs 156 have been fabricated with a decreased width as compared to the width of the row VCOMs 158. As illustrated, the column VCOMs 156 may be fabricated to be substantially narrower (e.g. decreased width) than the row VCOMs 158. For example, in one embodiment, the resistance of the column VCOMs 156 and the row VCOMs 158 may be generally expressed as:

$${R}_{VCOM} = \frac{{τ}_{VCOM}}{{C}_{VCOM}} = ρ ( \frac{{d}_{VCOM}}{{L}_{VCOM} \times {W}_{VCOM}} ) . \qquad equation ( 1 )$$

In equation (1), τ_{VCOM} may represent the decay time constant of the column VCOMs 156 and the row VCOMs 158. Similarly, C_{VCOM} may represent the total capacitance connected (e.g., by way of common electrodes 112) to the column VCOMs 156 and the row VCOMs 158. Thus, R_{COM} (e.g., the total resistance of the column VCOMs 156 and the row VCOMs 158) may be calculated as the decay time constant T_{VCOM} over the total capacitance C_{VCOM}, or in another embodiment, as the resistivity ρ multiplied by a gap d_{VCOM}, and divided by the area (e.g., L_{VCOM}×W_{VCOM}) of the column VCOMs 156 and the row VCOMs 158.

Therefore, as can be deduced by the above equation (1), the resistance of the column VCOMs 156 and the row VCOMs 158 may be inversely proportional to the width W_{VCOM} of the column VCOMs 156 and the row VCOMs 158. Thus, by fabricating the column VCOMs 156 with a decreased width W_{CVCOM} (e.g., as compared to the width W_{RVCOM} of the row VCOMs 158), the resistance R_{VCOM} of the column VCOMs 156 may be increased. As previously noted with respect to FIG. 5, this increase in resistance R_{VCOM} of the column VCOMs 156 may reduce and/or substantially eliminate the occurrence of mura artifacts (e.g., VSFOM) that may, for example, become apparent on the display 18.

In certain embodiments, the row VCOMs 158 may be fabricated with a width W_{RVCOM} of approximately 4-5 microns (μm) or greater, while the width W_{CVCOM} of the column VCOMs 156 may be reduced to, for example, approximately 3 μm or less. In other embodiments, the respective widths W_{RVCOM} and W_{CVCOM} of the column VCOMs 156 and the row VCOMs 158 may be fabricated according to a predetermined ratio. For example, the ratio of the respective widths W_{RVCOM} and W_{CVCOM} may include a 1.5:1 ratio, a 2:1 ratio, a 3:2 ratio, a 4:3 ratio, or other ratio and/or range of ratios (e.g., 1.5:1 to 4:3) in which the width W_{CVCOM} of the column VCOMs 156 is substantially less than the width W_{RVCOM} of the row VCOMs 158. In this way, by fabricating the column VCOMs 156 with a decreased width W_{CVCOM} (e.g., as compared to the width W_{RVCOM} of the row VCOMs 158), the resistance R_{CVCOM} of the column VCOMs 156 may be increased in relation to the resistance of the row VCOMs 158, and the occurrence of a mura artifact (e.g., VSFOM caused by variations in voltage perturbation) that may otherwise become apparent on the display 18 may be reduced and/or substantially eliminated. In other words, fabricating the column VCOMs 156 to have thinner widths W_{CVCOM} then the widths W_{RVCOM} of the row VCOMs 158 may cause the row VCOMs 158 and the column VCOM 156 to have resistance that are more likely to be equal to one another.

In certain embodiments, to facilitate the fabrication of the column VCOMs 156 and the row VCOMs 158 in accordance with the present embodiments (e.g., including the decreased width and/or one or more discontinuances) and/or to further reduce the effects of variations in voltage perturbation on the column VCOMs 156 and the row VCOMs 158, the column VCOMs 156 and the row VCOMs 158 may be fabricated using a metal mesh material. The column VCOMs 156 and the row VCOMs 158 may be fabricated using the metal mesh material in addition to, or alternatively to using other materials such as, indium-tin-oxide (ITO). Specifically, constructing the column VCOMs 156 and the row VCOMs 158 using the metal mesh materials may provide advantages such as, for example, allowing the VCOM electrodes and related bordering connections to be deposited at substantially the same time and may also provide other electrical characteristics (e.g., uniformity) that may be useful in reducing the effects of variations in voltage perturbation, and thus the effects of mura artifacts (e.g., VSFOM).

In certain embodiments, as illustrated in FIGS. 7-13, the column VCOMs 156 may be fabricated to include one or more discontinuances (e.g., segments and/or breaches in the electrodes of the column VCOMs 156) to increase the resistance on the column VCOMs 158. Specifically, the column VCOMs 156 may include electrode segments, such that the column VCOMs 156 may not touch or interfere with the row VCOMs 158 as the electrodes intersect. Specifically, as will be discussed in further detail below, FIGS. 7-10 each depict example embodiments of the column VCOMs 156 including a single “floating” electrode (e.g., column VCOM 156A) discontinuance, while FIGS. 11-13 depict example embodiments of the column VCOMs 156 including segmented electrodes (e.g., column VCOMs 156A and 156B) and discontinuances.

For example, as illustrated by FIG. 7, in one embodiment, the column VCOMs 156 may include a discontinuance 160 (e.g., floating electrode) with respect to only the column VCOM 156A. Specifically, the one or more discontinuances (e.g., discontinuance 160) may create a floating electrode (e.g., column VCOM 156A) that may be isolated from certain effects of the voltage of the pixel electrodes 110, and thus exhibit a higher resistance than the column VCOM 156A may have otherwise exhibited without the discontinuance 160.

In certain embodiments, it may be advantageous to fabricate the column VCOMs 156 to exhibit substantially the same resistance as the row VCOMs 158. Specifically, by including the discontinuance 160 with respect to the column VCOM 156A, the overall resistance of the column VCOM 156A may be increased. Additionally, the one or more discontinuances (e.g., discontinuance 160) of the column VCOMs 156 may be introduce at different points on the column VCOMs 156. For example, as illustrated by FIG. 8, discontinuance 162 may be provided on the column VCOMs 156 in such a manner that the lesser portion of the column VCOM 156A may float with respect to the row VCOMs 158.

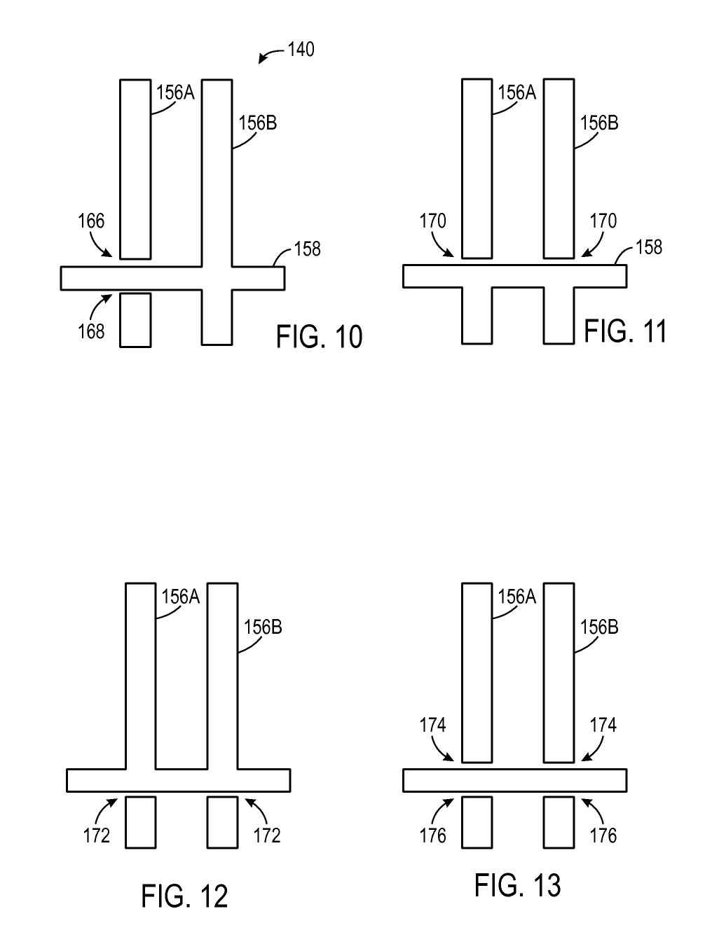

Similarly, as illustrated by FIG. 9, discontinuances 164 and 165 may be provided with respect to the larger portion of the column VCOM 156A and the smaller portion of the column VCOM 156B, respectively. As further illustrated by FIG. 9, the discontinuances 164 and 165 may be introduced on opposite sides of the row VCOMs 158. FIG. 10 illustrates discontinuances 166 and 168 introduced with respect the column VCOM 156A. As depicted, the discontinuance 166 may be fabricated with respect to the larger portion of the column VCOM 156A, while the second discontinuance 168 of the column VCOM 156A may be fabricated with respect to the smaller portion of the column VCOM 156A. In each embodiment, the overall resistance on the column VCOMs 156 may be increased (e.g., increased to the resistance of the row VCOMs 158) to mitigate that differences in voltage perturbations that may occur on the column VCOMs 156 and the row VCOMs 158 to reduce and/or substantially eliminate the occurrence of mura artifacts (e.g., VSFOM) that may, for example, become apparent on the display 18. Furthermore, although FIGS. 7-13 depict one or more embodiments illustrating the arrangement and/or the position along which the discontinuances (e.g., segments and/or breaches in the electrodes of the column VCOMs 156) may be introduced on the column VCOMs 156, it should be appreciated that FIGS. 7-13 are merely included for the purpose of illustration. That is, in other embodiments, a given column VCOM 156 (e.g., column VCOM 156A, column VCOM 156B) may itself include multiple discontinuances (e.g., discontinuance 160) positioned along any portion of the column VCOMs 156 insofar as the overall resistance on the column VCOMs 156 may be increased.

For example, as illustrated by FIGS. 11-13, each column VCOM 156 (e.g., column VCOM 156A, column VCOM 156B) may include multiple discontinuances (e.g., segmented electrodes) provided to increase the resistance of the column VCOMs 156 to substantially matched the resistance of the row VCOMs 158. For instance, FIG. 11 illustrates discontinuances 170, in which a respective discontinuance (e.g., discontinuances 170) has been introduced with respect to the larger portions of each of the column VCOMs 156A and 156B. Similarly, FIG. 12 illustrates discontinuances 172, in which a respective discontinuance (e.g., discontinuances 172) has been introduced with respect to the smaller portions of each of the column VCOMs 156A and 156B. Still similar, FIG. 13 illustrates discontinuances 174 and 176, in which the respective discontinuances 174 and 176 have been introduced with respect to both the smaller portions of each of the column VCOMs 156A and 156B and the larger portions of the column VCOMs 156A and 156B. In this way, by fabricating the column VCOMs 156 with floating column VCOMs and/or segmented column VCOMs, the resistance R_{VCOM} of the column VCOMs 156 may be increased, and the occurrence of any mura artifacts (e.g., VSFOM caused by variations in voltage perturbation) that may become apparent on the display 18 may be reduced and/or substantially eliminated.

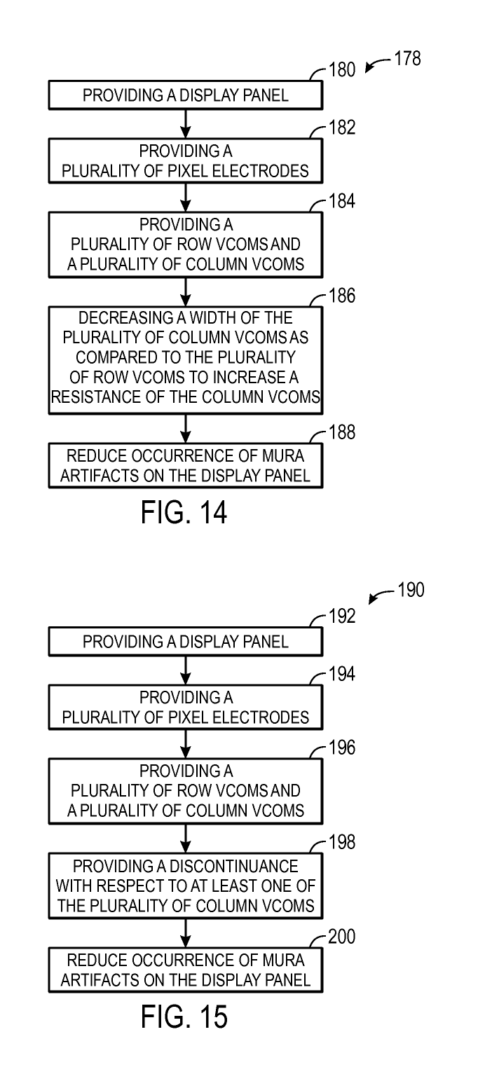

Turning now to FIG. 14, a flow diagram is presented, illustrating an embodiment of a process 178 useful in reducing and/or substantially eliminating mura artifacts (e.g., vertical stripe features of merit (VSFOM)) on an electronic display by fabricating, for example, the column VCOMs to include a physical width that is substantially less than the physical width of the row VCOMs of the display 18 included within the system 10 depicted in FIG. 1. The process 178 may begin with providing (block 180) a display panel (e.g., display 18). The process 178 may then continue with providing (block 188) pixel electrodes. For example, as noted above with respect to FIG. 4, the display 18 may include unit pixels 102 that include a TFTs 108 for supplying a data signal to store image data on a respective pixel electrodes 110.

The process 178 may then continue with providing (block 184) a number of row VCOMs 158 and a number of column VCOMs 156 of the display panel. For example, as noted above with respect to FIG. 5, touch drive electrodes 152 and touch sense electrodes 154 may include column VCOM 156 electrodes and row VCOM 158 electrodes. The process 178 may then continue with decreasing (block 186) a width of the number of column VCOMs 156 as compared to the number of row VCOMs 158 to increase a resistance of the column of the number column VCOMs 156. For example, as noted above with respect to FIG. 6, the resistance of the column VCOMs 156 and the row VCOMs 158 may be inversely proportional to the width W_{VCOM} of the column VCOMs 156 and the row VCOMs 158. Thus, by fabricating the column VCOMs 156 with a decreased width W_{CVCOM} (e.g., as compared to the width W_{RVCOM} of the row VCOMs 158), the resistance R_{VCOM} of the column VCOMs 156 may be increased. The process 178 may then conclude with reducing (block 188) or substantially eliminating the occurrence of mura artifacts (e.g., VSFOM) that may, for example become apparent, on the display 18. Specifically, the occurrence of the mura artifacts may be reduced and/or substantially eliminated based on the decreased width, and, by extension, the increased resistance of the column VCOMs 156.

Turning now to FIG. 15, a flow diagram is presented, illustrating an embodiment of a process 190 useful in reducing and/or substantially eliminating mura artifacts (e.g., vertical stripe features of merit (VSFOM)) on an electronic display by fabricating, for example, the column VCOMs to include one or more discontinuances (e.g., segments and/or breaches in the electrodes of the column VCOMs 156) to increase the resistance on the column VCOMs of the display 18 included within the system 10 depicted in FIG. 1. The process 190 may begin with providing (block 192) a display panel (e.g., display 18). The process 190 may then continue with providing (block 194) a number of pixel electrodes 110.

The process 190 may then continue with providing (block 196) a number of row VCOMs 158 and a number of column VCOMs 156 of the display panel. For example, as noted above with respect to FIG. 5, touch drive electrodes 152 and touch sense electrodes 154 may include column VCOM 156 electrodes and row VCOM 158 electrodes. The process 190 may then continue with providing (block 198) a discontinuance with respect to at least one of the number of column VCOMs 156. Specifically, the column VCOMs 156 may be fabricated to include a discontinuance 160 with respect to at least one column VCOM (e.g., column VCOM 156A as illustrated in FIGS. 7-10), such that at least one of the column VCOMs 156 creates a “floating” electrode, and thus increases the resistance on the column VCOMs 156 that includes the discontinuance 160.

In another embodiment, the column VCOMs 156 may be fabricated to include one or more discontinuances 170, for example, with respect to each column VCOM (e.g., column VCOMs 156A and 156B as illustrated in FIGS. 11-13), such that each of the column VCOMs 156 are segmented to increase resistance on the column VCOMs 156. The process 190 may then conclude with reducing (block 200) or substantially eliminating the occurrence of mura artifacts (e.g., VSFOM) that may become apparent, for example, on the display 18. Specifically, the occurrence of the mura artifacts may be reduced and/or substantially eliminated based on the inclusion of the discontinuances with respect to column VCOMs 156, and, by extension, the increased resistance of the column VCOMs 156.

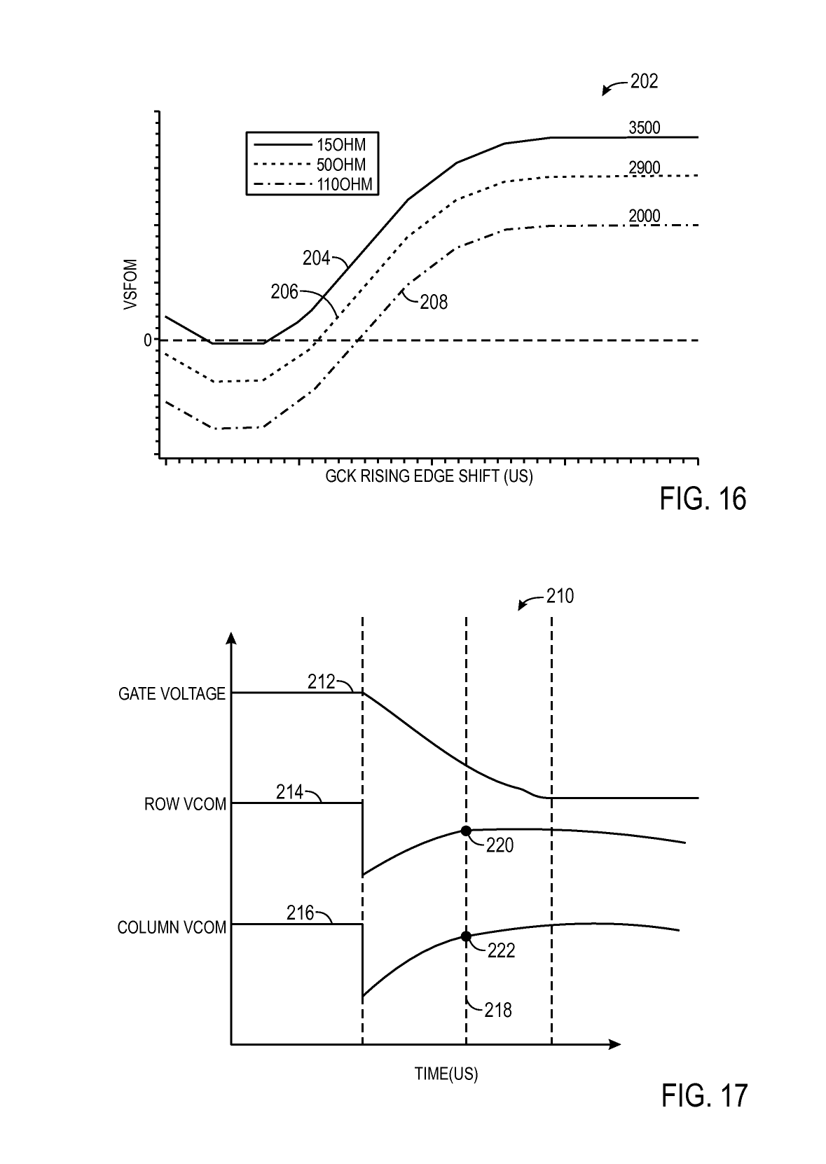

FIG. 16 illustrates a plot of mura artifact (e.g., VSFOM) visibility versus rising edge shift of the gate clock signal as a function of time (e.g., μs) for a column VCOM resistance of 15 ohms, 50 ohms, and 110 ohms, respectively. The mura artifact (e.g., VSFOM) visibility (e.g., which may include a dimensionless and/or dimensional value) may be detected and/or measured via a camera or other optical detection device during, for example, the fabrication and/or testing and verification of the display 18. As generally depicted by FIG. 16 and as previously noted, the mura artifact (e.g., VSFOM) visibility may be inversely proportional to the resistance of the VCOMs. For example, as illustrated, for a column VCOM resistance of approximately 15 ohms, the mura artifact (e.g., VSFOM) visibility may exhibit a value of approximately 3500. Similarly, for a column VCOM resistance of approximately 50 ohms, the mura artifact (e.g., VSFOM) visibility may exhibit a value of approximately 2900. However, by way of the present techniques discussed herein such as, for example, decreasing the physical width of the column VCOMs (e.g., column VCOMs 156) as compared to the row VCOMs (e.g., row VCOMs 158) and/or including discontinuances with respect to the column VCOMs to increased the resistance of the column VCOMs (e.g., to a resistance value of approximately the same value of the respective row VCOMs), the mura artifact (e.g., VSFOM) visibility may be substantially reduced. For example, as again depicted, for a column VCOM resistance of approximately 110 ohms, the mura artifact (e.g., VSFOM) visibility may measure a value of approximately 2000 or less.

FIG. 17 illustrates the voltage levels 210 of the gate voltage (line 212), row VCOM (line 214), and the column VCOM (line 216), in which the column VCOMs 156 has been fabricated with a decreased physical width and/or to include discontinuances as discussed above. As illustrated, the gate voltage (line 212) may fall at the point of TFT gate deactivation 217. Likewise, the row VCOM voltage (line 214) and column VCOM voltage (line 216) may fall as well, due to the capacitive coupling between the VCOMs 156 and 158 and the gate line 104. Specifically, the row VCOMs 158 may experience a rise time of 218 in order to return to its original voltage (point 220). Similarly, the column VCOMs 156 may also experience a rise time of 218 in order to return to its original voltage level (point 222) due to, for example, the increased resistance on the column VCOMs 156 in accordance with the presently disclosed techniques. Furthermore, although not illustrated, it should be appreciated that the row pixel voltage and column pixel voltage may experience a correspondingly similar rise time (e.g., rise time 218) in response to TFT gate deactivation. Thus, variations in voltage perturbation between the column VCOMs 156 and the row VCOMs 158 may be largely reduced and/or substantially eliminated, and, by extension, the occurrence of any mura artifacts (e.g., VSFOM caused by variations in voltage perturbation) that may become apparent on the display 18 may be reduced and/or substantially eliminated.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A display panel, comprising:
a plurality of row common voltage (VCOM) electrodes each configured with a first width, wherein the plurality of row VCOM electrodes extends along a first direction of the display panel; and
a plurality of column VCOM electrodes each configured with a second width, wherein the plurality of column VCOM electrodes extends along a second direction of the display panel perpendicular to the first direction;
wherein the second width of the plurality of column VCOM electrodes is substantially less than the first width of the plurality of row VCOM electrodes to increase a resistance of the plurality of column VCOM electrodes in relation to a resistance of the plurality of row VCOM electrodes that would occur if the second width were the same as the first width, and wherein increasing the resistance of the plurality of column VCOM electrodes comprises substantially preventing or otherwise reducing an occurrence of an image artifact on the display panel.

2. The display panel of claim 1, wherein the first width comprises a width equal to or greater than approximately 4 microns (μm).

3. The display panel of claim 1, wherein the second width comprises a width equal to or less than approximately 3 microns (μm).

4. The display panel of claim 1, wherein the plurality of row VCOM electrodes and the plurality of column VCOM electrodes comprise a metal mesh material.

5. The display panel of claim 1, wherein the row VCOM electrodes comprise touch drive electrodes and the column VCOM electrodes comprise touch sense electrodes.

6. The display panel of claim 1, wherein a value of the resistance of the plurality of column VCOM electrodes is increased to substantially a value of a resistance of the plurality of row VCOM electrodes to prevent the occurrence of the image artifact on the display panel.

7. The display panel of claim 1, wherein at least one of the plurality of column VCOMs comprises a discontinuance configured to substantially separate a first portion and a second portion of the at least one of the plurality of column VCOMs.

8. The display panel of claim 1, wherein a ratio between the first width and the second width comprises a ratio within a range from approximately 1.5:1 to approximately 2:1.

9. The display panel of claim 1, wherein a ratio between the first width and the second width comprises a ratio within a range from approximately 2:1 to approximately 3:2.

10. The display panel of claim 1, wherein a ratio between the first width and the second width comprises a ratio within a range from approximately 3:2 to approximately 4:3.

11. The display panel of claim 1, wherein the image artifact comprises a vertical stripe feature of merit (VSFOM).

12. A method for fabricating an electronic display, comprising:
providing a plurality of pixel electrodes configured to store image data; and
providing a plurality of row common voltage (VCOM) electrodes and a plurality of column VCOM electrodes, wherein the plurality of row VCOM electrodes and the plurality of column VCOM electrodes are configured to receive a common voltage signal and wherein the plurality of column VCOM electrodes comprises a decreased physical width with respect to the plurality of row VCOM electrodes to increase a resistance of the plurality of column VCOM electrodes with respect to a resistance that would otherwise occur if the row and column VCOM electrodes had the same width, and wherein the increased resistance of the plurality of column VCOM electrodes reduces or eliminates an occurrence of a mura artifact on the electronic display.

13. The method of claim 12, comprising providing a metal mesh material to construct each of the plurality of row VCOM electrodes and the plurality of column VCOM electrodes.

14. The method of claim 12, wherein providing the plurality of row VCOM electrodes comprises providing a plurality of VCOM electrodes including a physical width of approximately 4-5 microns (μm), and wherein providing the plurality of column VCOM electrodes comprises providing a plurality of VCOM electrodes including a physical width of approximately 3 microns (μm).

15. The method of claim 12, wherein the increased resistance of the plurality of column VCOM electrodes is substantially equal to a resistance of the plurality of row VCOM electrodes.

16. A method for fabricating an electronic display, comprising:
providing a plurality of pixel electrodes configured to receive an image data signal; and
providing a plurality of row common voltage (VCOM) electrodes and a plurality of column VCOM electrodes, wherein the plurality of row VCOM electrodes and the plurality of column VCOM electrodes are configured to receive a common voltage signal;
wherein the plurality of column VCOM electrodes comprises a discontinuance with respect to at least one of the plurality of column VCOM electrodes to increase a resistance of the plurality of column VCOM electrodes, wherein the discontinuance is configured to reduce or substantially eliminate an occurrence of mura artifacts on the electronic display.

17. The method of claim 16, wherein providing the plurality of column VCOM electrodes including the discontinuance with respect to the at least one of the plurality of column VCOM electrodes comprises providing a floating electrode to increase the resistance of the plurality of column VCOM electrodes.

18. The method of claim 16, wherein providing the plurality of column VCOM electrodes comprises providing a second discontinuance with respect to the at least one of the plurality of column VCOM electrodes.

19. The method of claim 18, wherein providing the plurality of column VCOM electrodes comprises providing a third discontinuance with respect to at least a second one of the plurality of column VCOM electrodes.

20. The method of claim 16, wherein providing the plurality of column VCOM electrodes comprises providing a plurality of discontinuances with respect to each of the plurality of column VCOM electrodes.

21. The method of claim 16, comprising providing a metal mesh material to fabricate each of the plurality of row VCOM electrodes and the plurality of column VCOM electrodes.

22. The method of claim 16, comprising providing a decreased physical width of the at least one of the plurality of column VCOM electrodes with respect to a physical width of at least one of the plurality of row VCOM electrodes to increase the resistance of the plurality column VCOM electrodes.

23. An electronic display panel, comprising:
a plurality of row common voltage (VCOM) electrodes, wherein the row VCOM electrodes extend along a first direction of the display panel; and
a plurality of column VCOM electrodes, wherein the column VCOM electrodes extend along a second direction of the display panel perpendicular to the first direction, wherein at least one of the plurality of column VCOM electrodes comprises one or more breaches configured to increase a resistance of the plurality of column VCOM electrodes.

24. The electronic display panel of claim 23, wherein the plurality of row VCOM electrodes does not comprise the one or more breaches.

25. The electronic display panel of claim 23, wherein each of the plurality of column VCOM electrodes comprises at least one breach.

26. The electronic display panel of claim 23, wherein the one or more breaches are configured to increase the resistance of the plurality of column VCOM electrodes to substantially eliminate or reduce an occurrence of an image artifact on the electronic display panel.
